(19) United States
(12) Patent Application Publication
(10) Pub. No.: US 2012/0272984 A1
(43) Pub. Date: Nov. 1, 2012

(54) ORAL HYGIENE IMPLEMENT AND METHOD OF USE

(76) Inventor: MARNI MARKELL HURWITZ, FAR HILLS, NJ (US)

(21) Appl. No.: 13/526,746

(22) Filed: Jun. 19, 2012

Related U.S. Application Data
(63) Continuation of application No. 12/903,415, filed on Oct. 13, 2010, now abandoned.

(51) Int. Cl. A61C 17/00; A46B 15/00; A46B 11/00; A61C 15/04

(52) U.S. Cl. 132/200; 132/309

(57) ABSTRACT

Oral hygiene implement including a handle, a first head mounted to the first end of the handle, a second head mounted to the second end of the handle, including a plurality of cleaning elements extending from the first head and the second head wherein the cleaning elements can exhibit releasable dentifrice retained in the cleaning elements.

### FIELD OF THE INVENTION

The present invention generally relates to the field of oral hygiene for humans and animals. More specifically, the present invention relates to a device and method of use of same for facilitating the cleansing of the areas of the mouth without damaging tooth enamel and creating irritation to the gum or other portions of the mouth area.

### BACKGROUND OF THE INVENTION

Oral hygiene is the practice of keeping the oral cavity clean to prevent dental concerns and limit the presence of bacteria in the mouth region resulting in bad breath. The use of oral care implements, such as toothbrushes, soft tissue cleaner devices, and combination devices of similar nature, is highly recommended as severe gum disease results in a substantial percentage of adult tooth loss. In addition, tooth decay is the most common global disease resulting from the generation of cavities inside pits and fissures on chewing surfaces where brushing cannot reach trapped and remaining food and saliva or fluoride have no access to neutralize acid and re-mineralize de-mineralized teeth.

Proper oral hygiene is essential for preventing calculus or tartar build-up, a form of hardened dental plaque (a sticky film exhibiting bacteria that forms on the teeth and gums capable of releasing acid that attacks tooth enamel and resulting tooth decay). Plaque accumulation causes the gingiva to become irritated and inflamed, resulting in the eventual loss of the connective tissue fibers that attach the gums to the teeth and bone that surrounds the tooth (i.e., periodontitis). The most common form of proper oral hygiene is the frequent and regular brushing of the mouth region and teeth with a toothbrush and the use of dental floss to prevent accumulation of plaque on the teeth. Supplemental oral hygiene methods and related implements such as tongue cleaning devices are utilized to remove the coating of bacteria commonly capable of causing bad breath, decaying food particles, fungi, and dead cells from the dorsal area of tongue. In addition, the use of mouthwash or other dental oral hygiene rinses may aid in the removal of bacteria.

Historically, a variety of oral hygiene measures have been used for teeth cleaning. For example, analysis of the activities of various worldwide cultures has resulted in evidence reflecting the use of chew sticks, tree twigs, bird feathers, animal bones, and porcupine quills as common devices for tooth cleaning and maintenance.

Today, the most common device utilized for proper oral hygiene is the toothbrush. In general, a toothbrush is an oral hygiene instrument used to clean the teeth and gums that consists of a head of clustered bristles fixed in a position on a handle, which facilitates the cleansing of areas of the mouth. Common toothpastes, a paste or gel dentifrice, are used in the conjunction with the toothbrush to improve the effectiveness of the movement of the toothbrush. Toothpaste acts as an abrasive that aids in removing the dental plaque and food from the teeth, assists in the elimination and/or masking of halitosis, and delivers active ingredients such as fluoride or xylitol to help prevent tooth and gum disease.

Toothbrushes are presently manufactured in numerous forms with a myriad of reported purposes and objectives designed to improve the effectiveness of the toothbrush. In particular, toothbrushes are available with different bristle textures, bristle types (including synthetic and animal hair bristles), and handle and brush head sizes and forms.

As the need for proper hygiene is so pervasive, the United States Patent and Trademark Office is replete with examples of attempts to satisfy this need. To that end, the United States Patent and Trademark Office has examined patent applications purporting solutions for dental care for over one hundred years including a patent issued to H. N. Wadsworth in 1857 (U.S. Pat. No. 18,653) for a device manufactured of a bone handle exhibiting bored holes for the placement of animal hair therewithin, which is likely the earliest issued patent in the field.

More advanced issued United States Patents for common oral care implements include the development of devices, methods, and means to eliminate mouth-borne bacteria. Conventional toothbrushes typically exhibit a head of a parallelogram shape containing fixed nylon bristle tufts. In certain advanced devices, additional cleansing structures may be employed for such desired purposes as massaging gums, cleaning the soft tissue of the tongue, or other like purposes.

A first example of an improved tooth-cleaning device is embodied in Hyman U.S. Pat. No. 3,754,295 which issued on Aug. 28, 1973. The purpose of the disclosed invention, entitled “Two-Headed Brush,” was to provide “a two-headed brush having a general utility and, more particularly, to a two-headed toothbrush.”

The Hyman invention was designed as a “two-headed brush comprising an elongated handle having a tapered structure, bristles secured to a relatively broad head portion of said handle and extending laterally there from, a second group of bristles attached to a narrow end portion of said.” The unique sizes (i.e., a narrow and a broad head) and positioning of the bristles on the opposing ends of the elongated handle were designed to “effect removal of plaque at the gum line without causing serious discomfort and irritation to the gum.”

While the application of Hyman was likely an important disclosure at the time of its issuance, such a primitive disclosure reveals many disadvantages.

Importantly, the design of the toothbrush heads have limited ability to retain dentifrice, mouthwashes, or other oral hygiene pastes and gels for the application on a tooth or soft tissue regions of the mouth. Therefore, the need for a solution that allows for the portability of a brushing device exhibiting a plurality of brushing heads and containing oral hygiene dentifrice or other similar oral hygiene materials in a single device continues to exist.

In a second example, a disposable and reusable toothbrush with toothpaste disposed in the handle of the device is disclosed in Lafortune U.S. Pat. No. 5,584,593. Lafortune acknowledges that certain contemporaneous art in the field exhibits improvements in the art, however, readily acknowledges certain shortcomings in the field. Specifically, Lafortune claims that while certain toothbrushes in the art employ a brush and dentifrice disposed therein thereby eliminating the need for both a toothbrush and a toothpaste tube such toothbrushes have been intended for long-time use and as a result “complex and expensive solutions” to the refilling of the handles with toothpaste have been implemented. “Also, in the prior toothbrushes, valves have been used which prevent the expulsion and waste of toothpaste and the contact of the toothpaste with air which would result in caking” and “[s]uch valves add significantly to the cost of the toothbrushes.”

Thus, Lafortune discloses a toothbrush having a front and back surface and a handle, neck and head. The disclosed handle contains a hollow area containing sufficient toothpaste for one to three brushings. The hollow area is covered with a compressible plastic pad which allows for the forcing of the toothpaste from the hollow area. The neck of the toothbrush contains a duct which leads from the hollow area of the handle to openings which are in the head of the toothbrush. According to the disclosure, a series of openings evenly dispersed throughout the bristle tufts in the head of the toothbrush allow for the user to force toothpaste through the openings to the bristle tufts.

According to the disclosure, the aforementioned design provides “an inexpensive combination of toothbrush and toothpaste which is effective to provide toothpaste from the handle to the bristles of the toothbrush” for one to three brushings. In addition, Lafortune is designed to “provide an inexpensive method for preventing the expulsion of toothpaste from the handle and the concurrent wasting and caking of toothpaste.”

While the Lafortune disclosure is clearly an improvement over the existing art, it is limited to its short-term use. Further, Lafortune is only useful for the application of toothpaste and does not employ a means to utilize additional oral hygiene products such as mouthwash or the like.

A further improvement in the prior art, Moskovich U.S. Pat. No. 5,628,082 entitled “Toothbrush with Improved Efficacy,” is directed to a brush “with a secure grip, a more effective bristle arrangement, and a specially shaped head . . . which is highly effective for the removal of plaque from teeth with manual brushing.” In discussing the background of the art at the time of the disclosure, Moskovich acknowledges certain shortcomings in the prior art. Moskovich readily acknowledges that it is the objective in the field of the art to (1) “provide effective surface area cleaning, including the top of the crown of the tooth and the frontal planar portions,” (2) “provide cleaning at the gumline, where debris often accumulates out of the reach of normal tongue cleaning action,” (3) “provide effective cleaning between teeth,” (4) “reach the most confined regions of the oral cavity easily,” (5) provide a device “capable of directing force at teeth and surfaces individually, while simultaneously allowing brushing of larger surface areas,” (6) provide a device that is “comfortable and convenient,” and (7) provide a device that “effectively removes plaque.” While the design employed by the Moskovich disclosure arguably accomplishes the aforementioned objectives, the disclosure fails to provide a singular device for the employment of a brushing mechanism and release and containment of toothpastes and other oral hygiene solutions.

An additional improvement in the related field of the present invention, includes the disclosure of Durana International Patent Application Number PCT/SK99/00006 entitled “Toothbrush.” Durana discloses an improved toothbrush containing a “polishing block” positioned in close proximity to the bristles of the toothbrush and in at least one embodiment, the polishing block further comprising an antibacterial substance or manufactured from a non-harmful, edible, elastic, and non-soluble material containing abrasive particles for tooth polishing. The Durana disclosure declares that the “main advantages of the toothbrush according to the [Durana invention] include the improved ability of the perfect mouth cleaning [and] a simultaneously better polishing of tooth enamel. Another possibility is the antibacterial effect even without tooth paste.” While the insertion of a “polishing block” is clearly the novelty of the Durana disclosure, clearly such use of a soluble “polishing block” can not be replenished once the block is depleted after one or more periods of use.

Frazell U.S. Pat. No. 5,915,868 entitled “Portable Toothbrush with Dentifrice” depicts a further improvement in the existing art. Specifically, Frazell provides ergonomic embodiments of a disposable toothbrush having self-contained dentifrice package and a soft, flexible plastic head for breaking the dentifrice package and sharp, hollow tubes or needles for distributing the dentifrice to the bristles. The Frazell invention is described as an improvement over related art in its “innovative mechanical design, in its ergonomic facility in both gripping the handle and moving the soft, rounded head through the mouth, and in its outward appearance.” Further, the invention is argued to exhibit “important mechanical innovations” as the “head behind the bristles is constructed of soft, flex-memory plastic which can be compressed to force the packet within it against puncture means to release the dentifrice.”

While clearly an improvement over the existing art, Frazell fails to explore and implement a system comprising a dual-head design and means for providing a single compact unit for the dispersion of multiple oral hygiene solutions.

Andersen U.S. Pat. No. 6,524,023 provides a further improvement in the existing art. Anderson discloses a first embodiment of a compact disposable toothbrush kit including a toothpaste dispensing device for dispensing a disposable toothbrush and a toothpaste stick which attaches to the handle using an edible adhesive. In a second embodiment, Andersen discloses a disposable toothbrush kit including a toothpaste dispensing device for dispensing a disposable toothbrush and a plastic toothpaste-containing vial, adhesively attached to the toothbrush. Andersen claims that the device exhibits several advantages over the existing art as “it eliminates multiple users of the common tube of toothpaste, providing separate individual doses of toothpaste to each person” and it aids in the decrease of “the spread of disease between family members and toothpaste users.” While the Andersen disclosure is likely an improvement over the then-existing art as it potentially exhibits its intended objective, the Andersen disclosure fails to provide a system comprising a dual-head design and means for providing a single unit for the dispersion of multiple oral hygiene solutions. Further, Andersen fails to provide a device capable of providing multiple layers of oral hygiene cleaning such as tongue cleansing or improved bristle placement.

Clark U.S. Pat. No. 6,769,828 discloses a plurality of embodiments of a chewable toothbrush. Specifically, Clark provides a chewable toothbrush including a pliable bristle anchor, bristles attached to the bristle anchor, and a handle attached to the bristle anchor. In one embodiment, the bristle anchor includes a cavity that holds a material such as toothpaste or mouthwash which is released from the cavity when the toothbrush is chewed by a user. The toothbrush disclosed by Clark may be a single-use disposable unit or as a multiple-use unit by reloading the dispensing portion. However, it will be readily apparent to one of ordinary skill in the art that Clark fails to disclose a dual-head design and means for providing a single unit for the dispersion of multiple oral hygiene solutions. Further, Clark fails to provide a device capable of providing multiple layers of oral hygiene cleaning such as tongue cleansing or improved bristle placement.

Turning yet to another disclosure in the related field of the art, Wong U.S. Patent Application No. 2005/0071939 discloses a “Dual Head Toothbrush.” The Wong U.S. Patent Application is directed to a toothbrush body including an integral head, a body, and a tail portion, wherein the head includes indents for receiving bristles and the tail portion, which is inclined relative to the body portion, includes an indent for receiving the base of an interdental brush. Clearly, the Wong disclosure includes more than one layer of oral hygiene cleaning (i.e., a toothbrush and an interdental brush designed to “clean areas of the mouth inaccessible or awkward to reach with the main brush”), however, Wong fails to provide a device capable of dispersing toothpaste or similar oral hygiene solutions.

U.S. Pat. No. 6,895,629 to Wenzler entitled “Double Sided Toothbrush” discloses a further development in the field of the relevant art. Wenzler is directed to an improved toothbrush employing a scrapper device opposite the toothbrush bristles. According to the disclosure, Wenzler is directed to a toothbrush having a handle and a head, wherein a plurality of relatively straight bristle fibers extend outward from one side of a bristle-supporting portion of the head to provide a looped coarse scrubbing surface. In addition, a plurality of looped fibers extend outward from another side of a looped fiber-supporting portion of the head, wherein an end of each looped fiber is fixably connected to the fiber supporting surface thereby providing a soft scrubbing loofah like surface. Further expanding on the disclosure, Wenzler claims that the straight bristles can be of varied length to aid in reaching crevices between the teeth and gums. In addition, the soft looped fibers can be used to scrub the roof of the mouth as well as the gum areas and the looped fiber supporting portion can be arcuate and can preferably extend beyond one hundred eighty to provide for a radial scrubbing surface aspect.

Wenzler includes more than one layer of oral hygiene cleaning (i.e., a toothbrush and a looped scrapping device for removal of bacteria from the roof portion of the mouth as well as the gum region). Like several of the earlier disclosures, Wenzler fails to provide a device capable of dispersing toothpaste or similar oral hygiene solutions in conjunction with the multiple oral cleansing devices.

Vazquez et al. International Patent Application No. PCT/US2008/054038 entitled “Toothbrush” further employs certain improvements to the common toothbrush. For example, Vazquez et al. discloses a plurality of toothbrush head configurations designed to “channel” user-applied toothpaste to the edges of the brush head. Vazquez et al. further discloses a head exhibiting a plurality of cleaning elements for enhanced cleaning of the teeth and the soft tissue of the oral cavity. Specifically, a first cleaning element comprises a plurality of bristles adapted to clean teeth while a second cleaning element is employed on the opposing side of the head to direct toothpaste previously applied by the user. The head further employs a location for the user-applied dentifrice so as to eliminate any user error allowing for the proper channeling of the dentifrice once in use. Numerous objectives of the Vazquez et al. invention are disclosed. For example, according to the specification, one of the features of Vazquez et al. is to provide a structure defining the channels including a plurality of members spaced from one another to define the recessed channels within gaps between the members and further including a plurality of protrusions forming a plurality of elongated ridges. Thus, the ridges and channels can have a variety of shapes, including serpentine shapes, arched shapes, and curved, elongated shapes. In addition, numerous cleaning elements are employed including a series of bristles adapted to clean teeth and a recessed reservoir defined and configured to receive user-applied dentifrice therein to assure proper placement of the dentifrice.

Each of these aforementioned features of Vazquez et al. are designed to improve the cleaning of the oral cavity. However, it is apparent from the disclosure that the present invention merely provides a recess for the placement of user-applied toothpaste from a common dispenser such as a tube rather than a portable device integrating the dentifrice therewithin. Further, Vazquez et al. fails to provide multiple cleaning implements for the application of more than one dentifrices such as toothpaste accompanied by a whitening gel or a mouthwash. Finally, Vazquez et al. fails to provide a means for integrating common dental floss or the like in a portable form in one integral unit.

A further prior art disclosure, entitled “Oral Care Implement” is directed to a portable, limited use toothbrush and an integral dispensing means for a dentifrice. In particular, Robinson et. al U.S. Patent Application Publication No. 2009/0320226A1, is directed to an oral care implement including a handle, a head mounted to one end of the handle that includes a first face having a plurality of tooth cleaning elements extending therefrom and a store of dentifrice retained at the head including a film matrix retained at the head containing at least one rapidly releasable agent. Robinson et al. further discloses the inclusion of a soft tissue cleaner included on a second face. It is further disclosed that the at least one rapidly releasable agent can be provided to the first and/or second faces during use from the film matrix wherein the at least one rapidly releasable agent can include, for example, a flavoring agent, a dentifrice, or a therapeutic agent. Finally, Robinson et al. is manufactured of a relatively small size and lightweight design so as to be readily portable for use away from the home.

Clearly, the benefit of the portability and integral design of Robinson et al. disclosure is an improvement over the known existing art. However, Robinson et al. still fails to provide multitude heads to allow for the application of discreet application of a plurality of dentifrice or related agents. Further, Robinson et al; fails to provide a plurality of cleaning implements to allow for tongue cleaning, roof cleaning, or other regions of the oral cavity, including hard to access regions. In addition, Robinson et al. fails to provide a means for the release of dental floss in one integral compact unit which is highly useful for personal at home use or use during travel.

In spite of the myriad of inventions and disclosures related to improved oral hygiene, it remains readily apparent that portable oral hygiene implements exhibit numerous shortcomings. Specifically, none of the aforementioned references provide for a hygienic and compact dual head toothbrush capable of adequately dispersing various oral hygiene solutions, pastes, and/or gels designed for single or multi-use which exhibits an ease of manufacture and limited complexity of use.

Therefore, the need still remains for a compact integral toothbrush exhibiting a myriad of cleaning elements for use with a plurality of dentifrice. Further, the need also remains for an inexpensive mechanism for single or multi-use which can be manufactured and refilled by the consumer at a consumer-appealing price.

### SUMMARY OF THE INVENTION

In view of the foregoing disadvantages inherent in the known and various oral care devices including those devices commonly developed for portable or single use, in accordance with a first preferred embodiment of the present invention, provided is a multi-use oral hygiene implement designed to improve oral care, especially oral care “on-the-go,” integrating a multitude of isolated dentifrices via a plurality of brushing heads and related cleaning elements. More specifically, the first preferred embodiment is designed to be utilized to reduce the presence of bacterium in the oral cavity of humans and animals by providing an integral unit employing dispensers for channeling and distributing toothpaste, toothpowder, therapeutic oral gels, mouthwashes, and the like as well as dental floss.

In short, in a primary embodiment, provided is a novel toothbrush with dentifrice feed system exhibiting ease of use and improved oral cleaning capability. The toothbrush, made of a common plastic material or the like, includes an ergonomic handle and grip mechanism for comfort of use and having a first head of ergonomic parallelogram shape positioned at a first end of the handle and a second head of ergonomic parallelogram shape positioned at a second end of the handle. The first head and second head employ a plurality of bristles of various shapes, lengths, strengths, and arrangements designed for particular cleaning aspects such as tooth cleaning, roof of mouth cleaning, tongue scrapping, plaque removal, gum massaging, etc. for maximum cleaning efficacy and various applications. Each head further including a plurality of grooves and channels to effectively distributing applied dentifrices during use of the oral care implement. Each head further including one or more reservoirs for maintaining a dentifrice pod or packet sealed in a soluble material such as a film. Such packets can contain any of a plurality of cleaning agents, including but not limited to toothpastes for improved tooth cleaning and mouthwash for killing germs in hard to reach places, freshening breath, loosening food caught between teeth, and fighting cavities.

Thus, the primary purpose of the present invention, which will be described subsequently in greater detail, is to provide a first embodiment concerning a single-use or multi-use compact oral cleansing device.

Continuing with the objects of the present invention, in a further embodiment, disclosed is a compact oral cleansing unit providing an enhanced dentifrice dispensing unit.

In keeping with the objects of the present invention, a further purpose of the present invention, which will be described subsequently in greater detail, is to provide an embodiment wherein a compact oral cleansing device exhibiting a multiple enhanced dentifrice dispensing units.

A further objective is to provide a compact oral cleansing device exhibiting a plurality of cleaning units as part of a single device.

In the aforementioned preferred and alternate embodiments, it will be readily apparent to those of ordinary skill in the art that various oral cleaning agents may be utilized in accordance with objectives of the invention disclosed herein.

Thus, there has been summarized and outlined, generally in broad form, a plurality of the most important features of the present invention, as described with respect to the foregoing preferred and alternate embodiments, in order that the following detailed description thereof which follows may be better understood by one of ordinary skill in the art. This summary and outline is further presented so that the novelty of the present contribution to the related art may be better appreciated. It will further be apparent that additional features of the invention described hereinafter and which will form the subject matter of the claims appended hereto will further define the scope, novelty, and in certain instances the improvements upon any existing art.

Further, it is to be readily understood that the invention presented herein is not limited in its application to the details of construction and to the arrangements of the components set forth in the following description or illustrated in the various figures integrated and categorized herein. The scope of the disclosure is presented in broad form so that other objects, features, and characteristics of the present invention, as well as the methods of operation and functions of the related elements of the structure, and the combination of parts and economies of manufacture, will become more apparent upon consideration of the following detailed description.

Those skilled in the art will appreciate that the disclosure of the present invention may readily be utilized as a basis for the designing of other similar structures, methods and systems for carrying out the various purposes and objectives of the present invention. Thus, the claims as set forth shall allow for such equivalent constructions insofar as they do not depart from the spirit and scope of the present invention as described herein.

### BRIEF DESCRIPTION OF THE DRAWINGS

A further understanding of the present invention and the objectives other than those set forth above can be obtained by reference to the various embodiments set forth in the illustrations of the accompanying figures. Although the illustrated embodiment is merely exemplary of systems for carrying out the present invention, both the organization and method of operation of the invention, in general, together with further objectives and advantages thereof, may be more easily understood by reference to the drawings and the following description. The figures are not intended to limit the scope of this invention, which is set forth with particularity in the claims as appended or as subsequently amended, but merely to clarify and exemplify the invention. The detailed description makes reference to the accompanying figures wherein:

FIG. 1A depicts a cross-sectional side view in accordance with the preferred embodiment of the present invention prior to the placement of encapsulated dentifrice in the reservoir of the first head and the second head.

FIG. 1B depicts a cross-sectional side view in accordance with the preferred embodiment of the present invention demonstrating the proper placement of encapsulated dentifrice in the reservoir of the first head and reservoir of the second head.

FIG. 2 depicts a bottom view in accordance with the preferred embodiment of the present invention exhibiting ergonomic elongated handle, the placement of encapsulated dentifrice in the reservoir of the first head and the second head, and the bristle structure of the first head and second head.

FIG. 3A depicts a top view in accordance with an alternate embodiment of the present invention exhibiting a handle and a grip as well as the placement of the dentifrice in the reservoir of the first head and the second head within the bristle structure and channels for the disbursement of the dentifrice.

FIG. 3B depicts a cross-sectional side view in accordance with an alternate embodiment of the present invention exhibiting an ergonomic handle and rubberized grip, the placement of a first dentifrice in the first reservoir of the top side of the first head, the placement of a second dentifrice in the second reservoir of the top side of the second head, a third cleaning element on the bottom side of the first head designed to cleanse the tongue, a fourth cleaning element on the bottom side of the second head designed to massage the gums, and a modified bristle structure of a wave shape to aid in the cleaning of the oral cavity.

FIG. 3C depicts a bottom view in accordance with an alternate embodiment of the present invention exhibiting handle and grip as well as a third cleaning element on the bottom side of the first head designed to cleanse the tongue and a fourth cleaning element on the bottom side of the second head designed to massage the gums.

FIG. 4 depicts a series of top views in accordance with an alternate embodiment of the present invention exhibiting numerous shapes and sizes of encapsulated dentifrice.

FIG. 5A depicts a cross-sectional side view in accordance with the preferred embodiment of the present invention prior to the placement of encapsulated dentifrice in the reservoir of the first head and the second head further exhibiting user-friendly designs and decoration.

FIG. 5B depicts a cross-sectional side view in accordance with the preferred embodiment of the present invention demonstrating the proper placement of encapsulated dentifrice in the reservoir of the first head and the second head further exhibiting user-friendly designs and decoration.

FIG. 6 depicts a bottom view of a plurality of packaged toothbrushes in accordance with the preferred embodiment of the present invention.

FIG. 7A depicts a top view in accordance with an alternate embodiment of the present invention exhibiting an ergonomic handle and rubberized grip as well as the placement of the dentifrice in the reservoir of the first removable and replaceable snap head and the removable and replaceable second snap head within the bristle structure and channels for the disbursement of the dentifrice.

FIG. 7B depicts a cross-sectional side view in accordance with an alternate embodiment of the present invention exhibiting an ergonomic handle and rubberized grip, the placement of a first dentifrice in the first reservoir of the top side of the removable and replaceable first snap head, the placement of a second dentifrice in the second reservoir of the top side of the removable and replaceable second snap head, a third cleaning element and fourth cleaning element on the bottom side of the first head and the second head, respectively, designed to cleanse the tongue, and a modified bristle structure of a wave shape to aid in the cleaning of the oral cavity.

FIG. 7C depicts a cross-sectional side view in accordance with an alternate embodiment of the present invention exhibiting an ergonomic handle and rubberized grip, the placement of a first dentifrice in the first reservoir of the top side of the removed first snap head, the placement of a second dentifrice in the second reservoir of the top side of the removed second snap head, a third cleaning element and fourth cleaning element on the bottom side of the first head and the second head, respectively, designed to cleanse the tongue, and a modified bristle structure of a wave shape to aid in the cleaning of the oral cavity.

FIG. 7D depicts a bottom view in accordance with an alternate embodiment of the present invention exhibiting an ergonomic handle and rubberized grip as well as a third cleaning element and fourth cleaning element on the bottom side of the first snap head and the second snap head, respectively, designed to cleanse the tongue.

FIG. 8A depicts a top view in accordance with an alternate embodiment of the present invention exhibiting an ergonomic handle and rubberized grip as well as the placement of the dentifrice in the reservoir of the first removable and replaceable twist head and the removable and replaceable second twist head within the bristle structure and channels for disbursement of the dentifrice.

FIG. 8B depicts a cross-sectional side view in accordance with an alternate embodiment of the present invention exhibiting an ergonomic handle and rubberized grip, the placement of a first dentifrice in the first reservoir of the top side of the removable and replaceable first twist head, the placement of a second dentifrice in the second reservoir of the top side of the removable and replaceable second twist head, a third cleaning element on the bottom side of the first twist head designed to cleanse the tongue, a fourth cleaning element on the bottom side of the second twist head designed to cleanse other soft tissue, and a modified bristle structure of a wave shape to aid in the cleaning of the oral cavity.

FIG. 8C depicts a cross-sectional side view in accordance with an alternate embodiment of the present invention exhibiting an ergonomic handle and rubberized grip, the placement of a first dentifrice in the first reservoir of the top side of the removed first twist head, the placement of a second dentifrice in the second reservoir of the top side of the removed second twist head, a third cleaning element on the bottom side of the first twist head designed to cleanse the tongue, a fourth cleaning element on the bottom side of the second twist head designed to cleanse other soft tissue, and a modified bristle structure of a wave shape to aid in the cleaning of the oral cavity.

FIG. 8D depicts a bottom view in accordance with an alternate embodiment of the present invention exhibiting an ergonomic handle and rubberized grip as well as a third cleaning element on the bottom side of the first twist head designed to cleanse the tongue and a fourth cleaning element on the bottom side of the second twist head designed to cleanse other soft tissue.

FIG. 9A depicts a top view in accordance with an alternate embodiment of the present invention exhibiting an ergonomic handle, rubberized grip, the placement of the dentifrice in the reservoir of the first removable and replaceable snap head, and a removable and replaceable second inclined interdental brush head.

FIG. 9B depicts a cross-sectional side view in accordance with an alternate embodiment of the present invention exhibiting an ergonomic handle and rubberized grip, the placement of a first dentifrice in the first reservoir of the top side of the removable and replaceable first snap head, removable and replaceable second inclined interdental brush head, a third cleaning element on the bottom side of the first head designed to cleanse the tongue, a fourth cleaning element on the bottom side of the second head designed to massage the gums, and a modified bristle structure of a wave shape to aid in the cleaning of the oral cavity.

FIG. 9C depicts a cross-sectional side view in accordance with an alternate embodiment of the present invention exhibiting an ergonomic handle and rubberized grip, the placement of a first dentifrice in the first reservoir of the top side of the removed first snap head, second inclined interdental brush head, a third cleaning element on the bottom side of the first head designed to cleanse the tongue, a fourth cleaning element on the bottom side of the second head designed to massage the gums, and a modified bristle structure of a wave shape to aid in the cleaning of the oral cavity.

FIG. 9D depicts a bottom view in accordance with an alternate embodiment of the present invention exhibiting an ergonomic handle and rubberized grip as well as a third cleaning element on the bottom side of the first snap head designed to cleanse the tongue and massage the gums.

FIG. 10 depicts a cross-sectional side view of the snap head in accordance with the alternate embodiment disclosed in FIG. 7A, FIG. 7B, FIG. 7C, and FIG. 7D of the present invention.

FIG. 11 depicts a cross-sectional side view of the twist head in accordance with the alternate embodiment disclosed in FIG. 8A, FIG. 8B, FIG. 8C, and FIG. 8D of the present invention.

FIG. 12 depicts a cross-sectional side view of the snap head interdental brush in accordance with the alternate embodiment disclosed in FIG. 9A, FIG. 9B, FIG. 9C, and FIG. 9D of the present invention.

FIG. 13A depicts a top view in accordance with an alternate embodiment of the present invention exhibiting a rubberized grip as well as the mechanism for the automatic placement and refill of the dentifrice in the reservoir of the first head and the second head within the bristle structure and channels for disbursement of the dentifrice.

FIG. 13B depicts a side view in accordance with an alternate embodiment of the present invention exhibiting a rubberized grip as well as a third cleaning element on the bottom side of the first head designed to cleanse the tongue and a fourth cleaning element on the bottom side of the second head designed to cleanse soft tissue.

FIG. 13C depicts a cross-sectional side view in accordance with an alternate embodiment of the present invention exhibiting a rubberized grip as well as the mechanism for the automatic placement and refill of the dentifrice in the reservoir of the first head and the second head within the bristle structure and channels for disbursement of the dentifrice and a third cleaning element on the bottom side of the first head designed to cleanse the tongue and a fourth cleaning element on the bottom side of the second head designed to cleanse soft tissue.

FIG. 13D depicts a bottom view in accordance with an alternate embodiment of the present invention exhibiting an ergonomic handle and rubberized grip as well as a third cleaning element on the bottom side of the first head designed to cleanse the tongue and a fourth cleaning element on the bottom side of the second head designed to cleanse soft tissue.

FIG. 14A depicts a top view in accordance with an alternate embodiment of the present invention exhibiting a rubberized grip as well as a manually employed mechanism for the forced injection and refill of the dentifrice in the reservoir of the first head and the second head within the bristle structure and channels for disbursement of the dentifrice.

FIG. 14B depicts a side view in accordance with an alternate embodiment of the present invention exhibiting a rubberized grip as well as a manually employed mechanism for the forced injection and refill of the dentifrice in the reservoir of the first head and the second head within the bristle structure and channels for disbursement of the dentifrice, further exhibiting a third cleaning element on the bottom side of the first head designed to cleanse the tongue and a fourth cleaning element on the bottom side of the second head designed to massage the gums.

FIG. 14C depicts a cross-sectional side view in accordance with an alternate embodiment of the present invention exhibiting a rubberized grip as well as a manually employed mechanism for the forced injection and refill of the dentifrice in the reservoir of the first head and the second head within the bristle structure and channels for disbursement of the dentifrice, further exhibiting a third cleaning element on the bottom side of the first head designed to cleanse the tongue and a fourth cleaning element on the bottom side of the second head designed to massage the gums.

FIG. 14D depicts a bottom view in accordance with an alternate embodiment of the present invention exhibiting a rubberized grip and a third cleaning element on the bottom side of the first head designed to cleanse the tongue and a fourth cleaning element on the bottom side of the second head designed to massage the gums.

FIG. 15A depicts a top view in accordance with an alternate embodiment of the present invention exhibiting a rubberized grip, a mechanism for the automatic placement and refill of the dentifrice in the reservoir of the first head and the second head within the bristle structure, channels for disbursement of the dentifrice, and a dental floss dispenser.

FIG. 15B depicts a side view in accordance with an alternate embodiment of the present invention exhibiting a rubberized grip, a dental floss dispenser, a third cleaning element on the bottom side of the first head designed to cleanse the tongue and a fourth cleaning element on the bottom side of the second head designed to massage the gums.

FIG. 15C depicts a cross-sectional side view in accordance with an alternate embodiment of the present invention exhibiting a rubberized grip, a mechanism for the automatic placement and refill of the dentifrice in the reservoir of the first head and the second head within the bristle structure, channels for disbursement of the dentifrice, a third cleaning element on the bottom side of the first head designed to cleanse the tongue, a fourth cleaning element on the bottom side of the second head designed to massage the gums, and a dental floss dispenser.

FIG. 15D depicts a bottom view in accordance with an alternate embodiment of the present invention exhibiting a rubberized grip, a third cleaning element on the bottom side of the first head designed to cleanse the tongue, a fourth cleaning element on the bottom side of the second head designed to massage the gums, and a floss dispenser.

FIG. 16A depicts a top view in accordance with an alternate embodiment of the present invention exhibiting a musical device positioned in ergonomic handle as well as the placement of the dentifrice in the reservoirs of the first removable and replaceable snap head and the second removable and replaceable snap head within the bristle structure.

FIG. 16B depicts a cross-sectional side view in accordance with an alternate embodiment of the present invention exhibiting a musical device positioned in ergonomic handle as well as the placement of dentifrice in the reservoirs of the first removable and replaceable snap head and the second removable and replaceable second snap head, a third cleaning element and fourth cleaning element on the bottom side of the first head and the second head, respectively, and channels for the distribution of the dentifrice.

FIG. 16C depicts a cross-sectional side view in accordance with an alternate embodiment of the present invention exhibiting a musical device positioned in ergonomic handle as well as the placement of dentifrice in the reservoirs of the un-inserted first removable and replaceable snap head and the un-inserted second removable and replaceable second snap head, a third cleaning element and fourth cleaning element on the bottom side of the first head and the second head, respectively, and channels for the distribution of the dentifrice.

FIG. 16D depicts a bottom view in accordance with an alternate embodiment of the present invention exhibiting a musical device positioned in ergonomic handle as well as a third cleaning element and fourth cleaning element on the bottom side of the first snap head and the second snap head, respectively, each designed to cleanse the tongue.

FIG. 16E depicts an exploded view cross-sectional side view of the center portion of the device depicted in FIG. 16B in accordance with an alternate embodiment of the present invention.

FIG. 17 depicts a perspective of a dispenser for storing, dispensing, and refilling the encapsulated dentifrice.

### DETAILED DESCRIPTION OF THE PREFERRED EMBODIMENT

A detailed illustrative embodiment of the present invention is disclosed herein. However, techniques, systems and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein which define the scope of the present invention. The following presents a detailed description of a preferred embodiment (as well as some alternative embodiments) of the present invention.

Moreover, well known methods, procedures, and substances for both carrying out the objectives of the present invention and illustrating the preferred embodiment are incorporated herein but have not been described in detail as not to unnecessarily obscure novel aspects of the present invention.

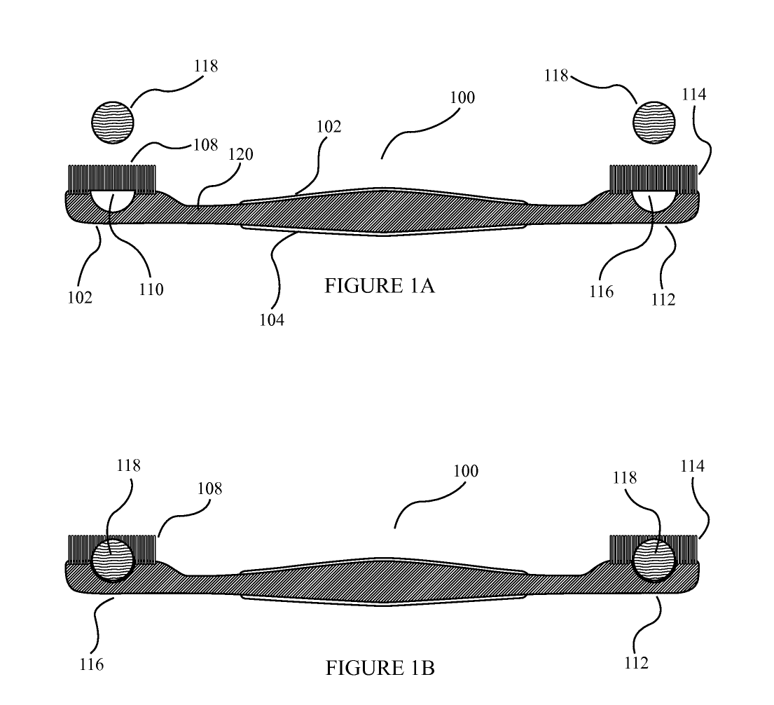

Referring first to FIG. 1A, depicted is a cross-sectional side view in accordance with the preferred embodiment of the present invention prior to the placement of dentifrice capsule 118. Specifically, provided is an ergonomic oral hygiene implement 100 composed of an elongated handle 120 exhibiting an upper grip 102 and a lower grip 104 to aid in the control by the user of oral hygiene implement 100. Oral hygiene implement 100 is designed primarily for the cleaning of the teeth and soft tissue of the oral cavity (e.g., exterior regions of the tongue, cheeks, gums, lips, etc.), either human or animal. Oral hygiene implement is designed of appropriate dimensions to foster use by a user and allow a user to readily grip the implement and manipulate the implement so as to allow for substantial cleaning of the mouth region. In the present embodiment upper grip 102 and lower grip 104 exhibit protrusions, indentations, and smooth surfaces to allow for improved grip and traction for the engaged gripping digits of the user. Upper grip 102 and lower grip 104 are positioned to allow the user to securely utilize oral hygiene implement 100 in a bristle-up, bristle-down, or any position therebetween to provide a three hundred sixty degree range of motion for complete cleaning of the upper teeth, lower teeth, and soft tissue of the oral cavity without fear of slipping between the upper grip 102, lower grip 104, and elongated handle 120 with the user's gripping digits.

Oral hygiene implement 100 is preferably molded of a suitable thermoplastic material as a single integral unit by any common method known in the art such as injection molding or casting. The gripping elements (i.e., upper grip 102 and lower grip 104), are preferably manufactured of a common rubber material, rubber-like material, or other suitable deformable thermoplastic. These gripping elements may be adhered to elongated handle 120 with a suitable adhesive or, in the alternative, may be matted to the thermoplastic material via a common injection molding process. However, one of ordinary skill in the art will readily recognize that such complexity in manufacturing an oral hygiene implement utilizing unique materials may yield more expensive manufacturing costs and as a result may not be employed in alternate embodiments so as to reduce the cost of manufacture. For example, a singular injection molding process may be utilized wherein oral hygiene implement 100 is manufactured of a single material such as a thermoplastic, resin, polypropylene, rubber, wood, metal, or the like, including combinations thereof.

As depicted, oral hygiene implement 100 is comprised of an opposing dual-head construction with a first head 106 comprising first head reservoir 110 and first head bristles 108 positioned at a first end of elongated handle 120 and a second head 112 comprising second head reservoir 116 and second head bristles 114 positioned at opposing second end of elongated handle 120. While not depicted, elongated handle can be manufactured to allow for the angled placement of first head 106 and/or second head 112 with respect to the longitudinal axis of elongated handle 120 to aid in the improved control of oral hygiene implement 100, as widely recognized in the art.

With respect to the present embodiment, first head bristles 108 and second head bristles 114 are composed of tufts of nylon fibers extending outward and secured at fiber securing portions substantially straight and perpendicular to first head 106 and second head 112. As depicted, fibers of first head bristles 108 and second head bristles 114 are substantially straight and of even length, however, one of ordinary skill in the art will readily recognize that fibers of varying length, dimensions, material types (such as thermoplastic elastomer, linear low density polyethylene, ethylene vinyl acetate, or other similar resilient flexible material of combination thereof) may be employed while not departing from the spirit of the invention.

First head reservoir 110 and second head reservoir 116 are designed as a refillable dispenser allowing for the acceptance of dentifrice capsule 118, depicted as a gel-filled pod. However, it is well recognized that non-refillable, single use reservoirs may be employed. In the preferred embodiment, first head reservoir 110 and second head reservoir 116 are of sufficient dimensions to hold dentifrice pod 118 in place without the need for an attachment means, however, first head reservoir 110 and second head reservoir 116 can include prongs, dimples, ridges, or similar protrusions to allow a user to forcibly place the dentifrice therein allowing the attachment means to clasp and position the dentifrice for use. In addition, adhering substances such as water-soluble non-toxic glues to maintain the dentifrice in the reservoir.

Dentifrice capsule 118 is preferably depicted as encapsulated as it exhibits certain inherent advantages over the traditional method of toothpaste application wherein toothpaste is forcibly extruded from a tube onto toothbrush bristle. First, it is well known in the art that the use of toothpaste extruded from tubes results in uneven distribution. The uneven distribution results in the first area to be brushed receiving excess toothpaste and areas brushed later receiving minimal toothpaste application. The portions that receive excess toothpaste often experience unhealthy enamel wear while the portions that receive too little are not effectively cleaned.

The encapsulated style dentifrice capsule 118 is preferably manufactured in spherical shape stabilized in a non-toxic, biocompatible thin coating or shell designed to release the contents when ruptured by teeth or dissolved by saliva. For example, the coating may be manufactured of gelatin, choline, or other common conventional coatings known in the art. Dentifrice capsule 118 is designed to accomplish a variety of oral care applications such as therapeutic applications, alleviation of dry mouth, removal of putative bacteria, removal of sulfur-based compounds, reduction of dental plaque and resulting gingivitis, reduction of mouth odor, cleaning and whitening of teeth of the oral cavity, etc. Dentifrice capsule 118 can include any common dentifrice such as any desired quantity of toothpaste or other standard oral care dentifrice, including, but not limited to toothpowder, toothcare gel, toothcare liquids, aqueous oral care solution, etc. It is well known in the art that dentifrice can include a foaming agent or surfactant, binding agents, gelatin to help solidify the solution, stabilizers, odor-reducing agents, antibacterial agents, whitening agents, anti-sensitivity agents, anti-tarter agents, anti-plaque agents, plaque highlighting agents, anti-inflammatory agents, colorants, baking soda, traditional detergents as well as favored minerals such as fluoride. Dentifrice may also include sweetening agents, flavoring agents, nutritional agents, anti-stain agents, dissolving agents, or quick-release agents such as mint films or the like. It is well known in the art that numerous compounds accomplish the aforementioned oral care, including, but not limited to chlorhexidine, cetyl pyridinium chloride, ethyl lauroyl argening HCl, triclosan, zinc salts, hydrogen peroxide, urea peroxide, sodium percarbonate, KNO₃, bachalin, polyphenols, triclosan, ethyl pyruvate, guanidinoethyl disulfide, vitamins, minerals, amino acids, folic acid, polyvinylphosphoric acid, or combinations thereof.

FIG. 1B depicts a cross-sectional side view in accordance with the preferred embodiment of the present invention demonstrating the proper placement of encapsulated dentifrice 118 in the first head reservoir 110 and second head reservoir 116. As referenced, first head reservoir 110 and second head reservoir 116 is designed to receive and retain dentifrice capsule 118. In this instance, dentifrice capsule 118 is spherical in shape and manufactured of slightly larger dimensions than dentifrice capsule 118 so that the user can forcibly place refillable dentifrice capsule 118 therein and first head reservoir 110 and second head reservoir 116 can thereby substantially retain rupturable dentifrice capsule 118 for proper use. It is further contemplated by the present invention that first head reservoir 110 and second head reservoir 116 may employ a cushioning effect so that upon acceptance of the dentifrice capsule 118 any excess pressure applied by the user may be counteracted thereby preventing premature eruption of dentifrice capsule 118. Dentifrice capsule 118 retains and applies the dentifrice therein in appropriate quantity onto first head bristles 108 and/or second head bristles 114 and corresponding channels of distribution (not shown) of first head 106 and/or second head 112, or other corresponding cleaning elements. The referenced dimensions can be of varied sizes designed to accept varied sizes of dentifrice capsule 118 or other oral care material. While the preferred embodiment of the present invention is designed to be a refillable implement, it is contemplated by the present invention that oral hygiene implement 100 may also be designed of suitable size for transport or single use as a disposable unit. Specifically, it is contemplated that oral hygiene unit 100 may be packaged in suitable form with a gel dentifrice, powder dentifrice, or the like, including combinations thereof that is readily transported, disposed, or utilized.

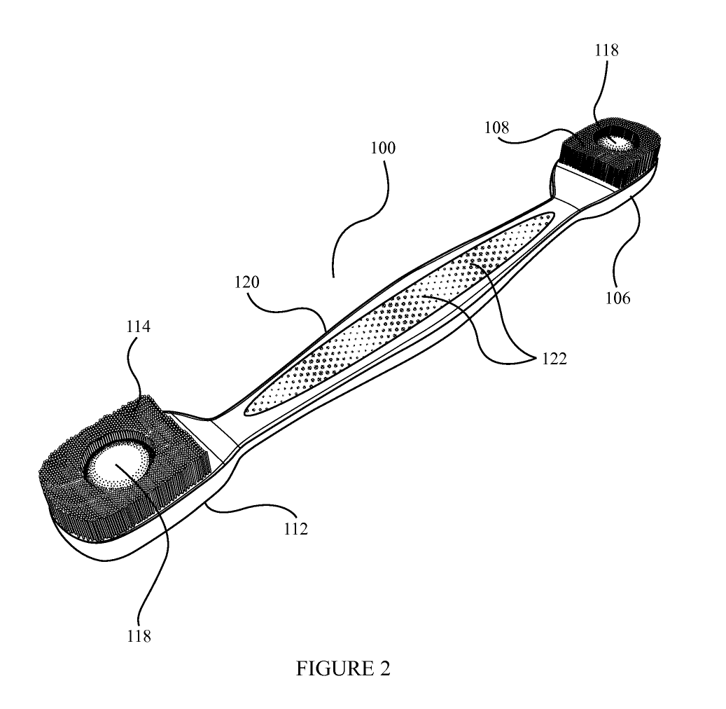

FIG. 2 depicts a bottom view in accordance with the preferred embodiment of the present invention exhibiting oral hygiene implement 100 comprising ergonomic elongated handle 120 and the placement of encapsulated dentifrice 118 in the first head 106 comprising first head reservoir 110 and first head bristles 108 positioned at a first end of elongated handle 120 and a second head 112 comprising second head reservoir 116 and second head bristles 114 positioned at opposing second end of elongated handle 120. Elongated handle 120 exhibit grip means 122 comprised of dimples, protrusions, concave formations, convex formations, ridges, and the like for improved control of the oral hygiene implement 100. It is further contemplated by the present invention that alternate grip means 122 may be employed such as thumb or digit prints, thumb or digit holes, suction mechanisms, or other like handle modifications to assist in improved grip by the user. One of ordinary skill in the art will readily recognize that substantial grip and stability is essential to the use of oral care devices as a means to protect the oral cavity and associated regions and limit damage to teeth and soft tissue as well as to assist in proper brushing of the region.

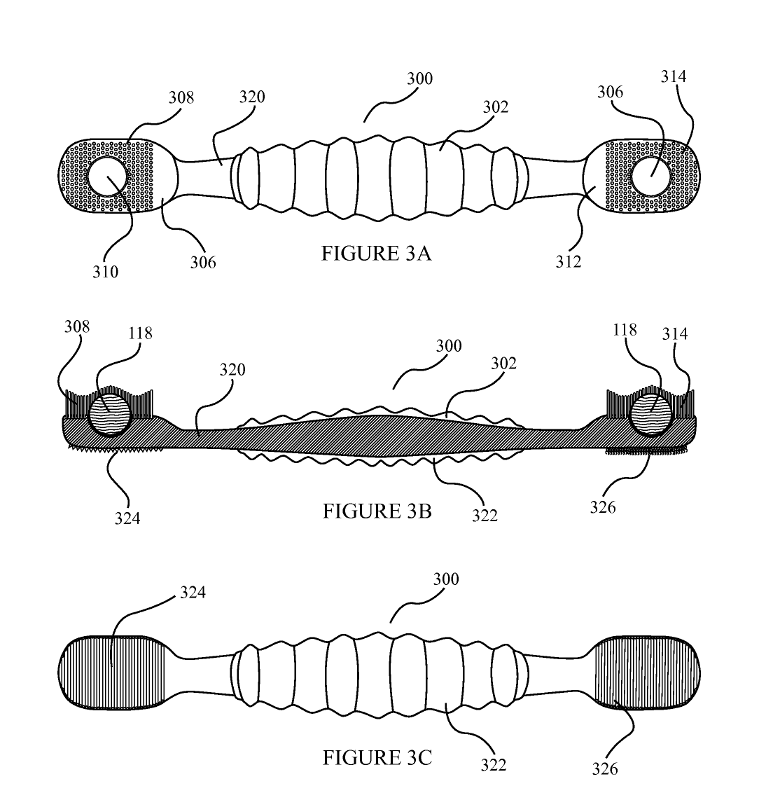

FIG. 3A depicts a top view in accordance with the preferred embodiment of the present invention exhibiting oral hygiene implement 300 having handle 320 and rubberized upper ridge grip 302 as well as the first head reservoir 310 positioned on first head 312, the second head reservoir 306 positioned on second head 306, first head bristles 314, and second head bristles 308. First head bristles 314 and second head bristles 308 are positioned in a lateral arrangement allowing for the promulgation of dentifrice between such bristles and redistribution of the dentifrice via channels (not shown) positioned in first head 312 and second head 306.

FIG. 3B depicts a cross-sectional side view in accordance with the alternate embodiment of FIG. 3A of the present invention exhibiting oral hygiene implement 300 having handle 320, rubberized upper ridge grip 302, and lower rubberized grip 322 as well as the first head reservoir 310 positioned on first head 312, the second head reservoir 306 positioned on second head 306, first head bristles 314, and second head bristles 308. Oral hygiene implement 300 includes a modified bristle structure of a wave shape to aid in the cleaning of the oral cavity. In addition to first head bristles 314 and second head bristles 308, oral hygiene implement 300 incorporates additional cleaning elements as depicted as tongue scrapper 326 on the bottom side of the first head designed to cleanse the tongue and gum massager 324 on the bottom side of the second head designed to massage the gums. It is well known in the art that various oral hygiene implements designed for cleaning one or more portions of the mouth, including teeth and soft tissues, are commonly used ranging from looped fibers, scrubbing loofahs, brushes, bristles, massagers, picks, flossing fibers and it is further contemplated by the present invention that a plurality of oral hygiene cleaning implements are utilized and incorporated into oral hygiene implement 300.

FIG. 3C depicts a bottom view in accordance with the alternate embodiment of FIG. 3A of the present invention exhibiting oral hygiene implement 300 having handle 320, rubberized upper ridge grip 302, and lower rubberized grip 322 as well as the first head reservoir 310 positioned on first head 312, the second head reservoir 306 positioned on second head 306, first head bristles 314, and second head bristles 308. In addition to first head bristles 314 and second head bristles 308, oral hygiene implement 300 incorporates additional cleaning elements as depicted as tongue scrapper 326 and gum massager 324.

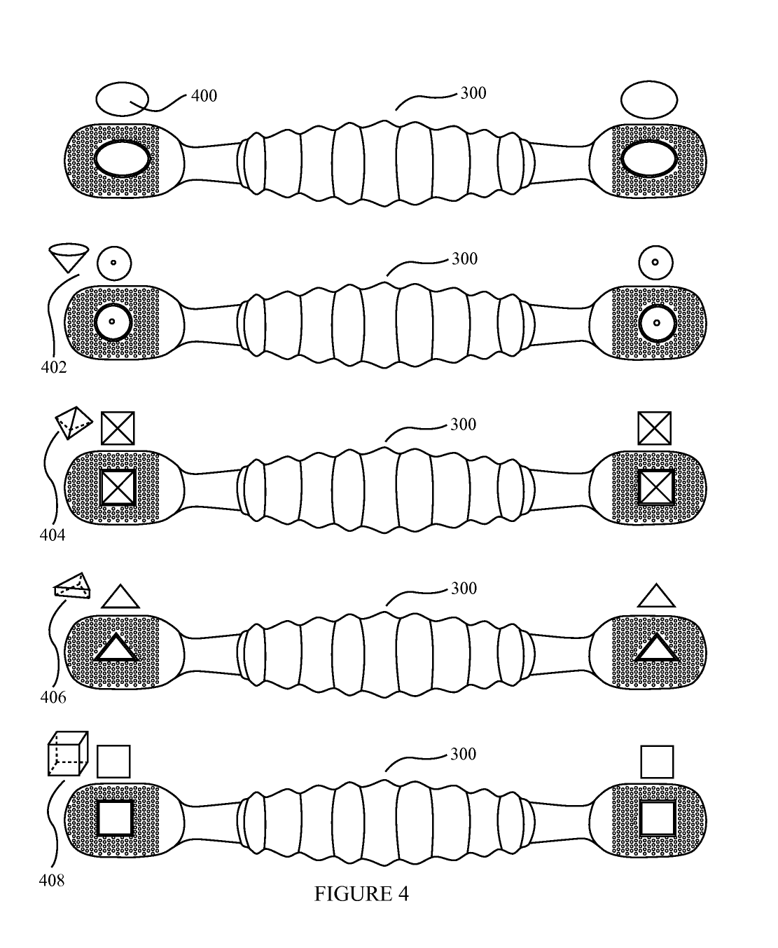

FIG. 4 depicts a series of top views in accordance he alternate embodiment of FIG. 3A of the present invention exhibiting various oral hygiene implement 300 head reservoirs of various shapes and sizes for the acceptance and retention of encapsulated dentifrice. As referenced, dentifrice can be any paste, liquid, or powder used to help maintain acceptable oral hygiene. While in the preferred embodiment as depicted in FIG. 1A and FIG. 1B, dentifrice capsule 118 is depicted as spherical shape stabilized in a non-toxic, biocompatible thin coating or shell designed to release the contents when ruptured by teeth or dissolved by saliva, it is contemplated by the present invention that dentifrice capsule may be manufactured in a myriad of aesthetically-pleasing and child friendly shapes to encourage use of the dentifrice. For example, FIG. 4 depicts oval-shaped dentifrice 400, conical-shaped dentifrice 402, pyramid-shaped dentifrice 404, elevated triangular-shaped dentifrice 406, and polygon-shaped dentifrice 408. Of course, one of ordinary skill in the art will readily recognize that the shaped dentifrice asserted herein are merely examples and that numerous shapes and sizes of dentifrice may be utilized in keeping with the objectives of the present invention.

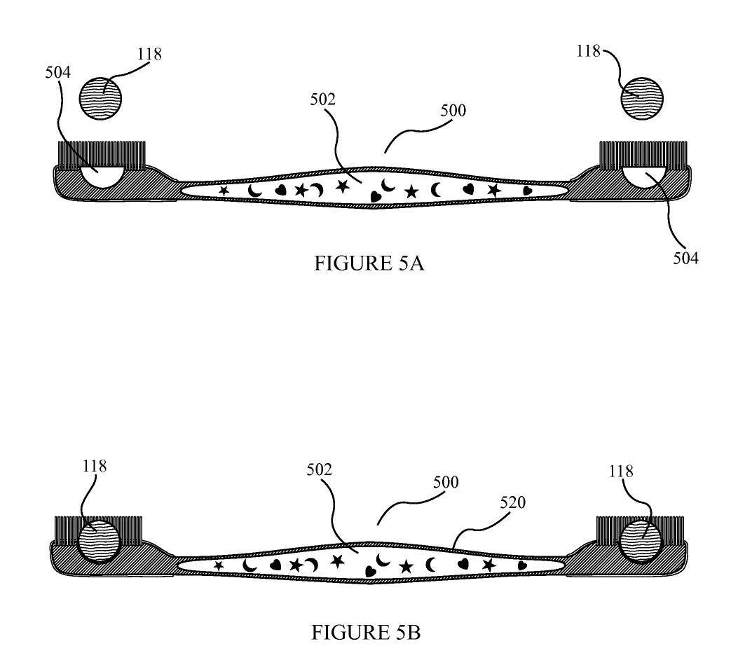

FIG. 5A depicts a cross-sectional side view in accordance with an alternate embodiment of the present invention wherein oral hygiene implement 500 is presented prior to the placement of encapsulated dentifrice 118 in the head reservoir 504 of the first head and the second head. Handle 520 of oral hygiene implement 500 further exhibits user-friendly design 502. FIG. 5B further depicts proper placement of encapsulated dentifrice 118 in the head reservoir 504 of the first head and the second head. While design 502 positioned on handle 520 is primarily presented as decoration, one of ordinary skill in the art can readily recognize that various designs (beyond the mere cosmic design depicted) may be employed to assist in the usage of oral hygiene implement 500. For example, a glow-in-the dark design may be employed to aid in nighttime usage of oral hygiene implement 500 or even to entice children into using the implement. Further, design 502 may be tailored to a particular user thereby preventing one user from contaminating another user's oral hygiene implement. Finally, design 502 may be positioned in such a manner to educate a user as to the proper grip positions for the most effective use of oral hygiene implement 500.

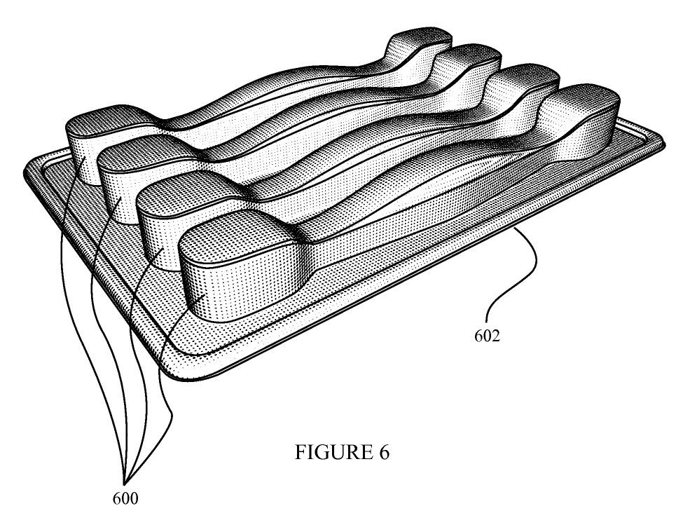

Turning to FIG. 6, depicted is a bottom view of a plurality of packaged oral hygiene implements in accordance with the preferred and alternate embodiments of the present invention. Packaging 602, such as common blister pack type packaging, is designed to securely allow for the transport of a plurality (in this case depicted as four) of oral care implements 600 in a safe manner thereby avoiding damage to oral care implement 600, damage to the dentifrice contained therein, or any cross contamination with various environment elements.

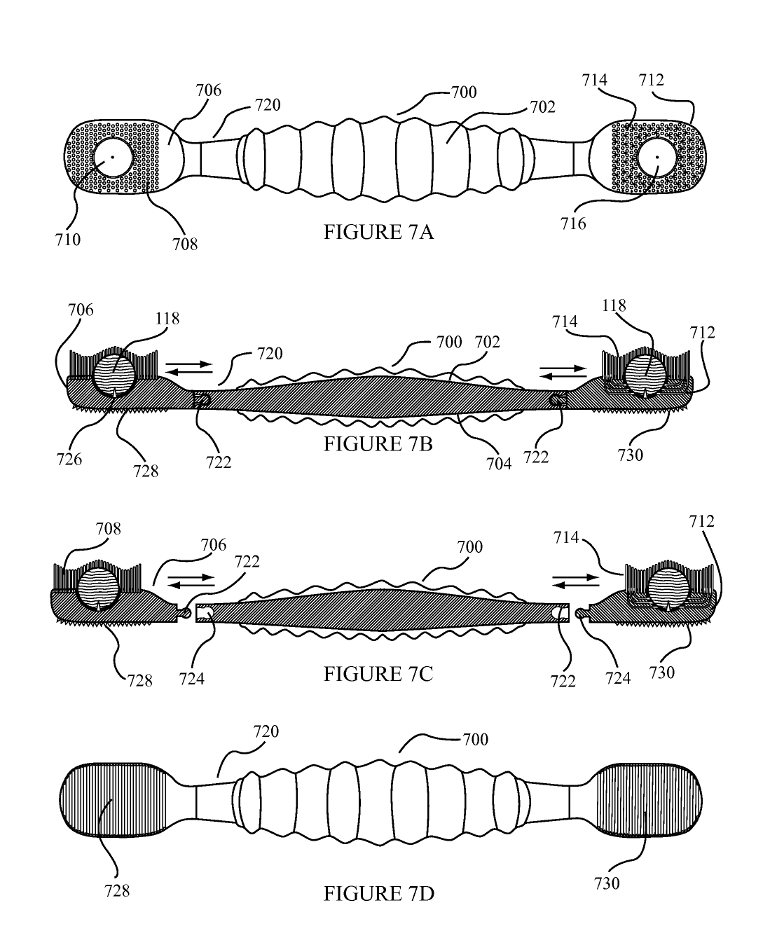

FIG. 7A through FIG. 7D depict an alternate embodiment of the present invention wherein oral hygiene implement 700 includes a plurality of removable and replaceable heads to allow for the incorporation of a series of oral hygiene cleaning implements. Specifically, FIG. 7A depicts a top view of oral hygiene implement 700 in accordance with the alternate embodiment, FIG. 7B depicts a cross-sectional side view of oral hygiene implement 700 in accordance with the alternate embodiment with attached first head 706 and second head 712, FIG. 7C depicts a cross-sectional side view of oral hygiene implement 700 in accordance with the alternate embodiment with attached first head 706 and second head 712, and FIG. 7D depicts a bottom view of oral hygiene implement 700 in accordance with the alternate embodiment.

Oral hygiene implement 700 of FIG. 7A through FIG. 7D of the present invention incorporates handle 720 and upper ridge grip 702. Oral care implement 700 includes first head reservoir 710 for placement of dentifrice capsule 118 therein positioned on first head 706, second head reservoir 716 for placement of dentifrice capsule 118 therein positioned on second head 712, first head bristles 708, second head bristles 714, first head cleaning element 728 (shown as a tongue cleaning implement), and second head cleaning element 730. First head bristles 708 and second head bristles 714 are positioned in a lateral arrangement allowing for the promulgation of dentifrice between such bristles and redistribution of the dentifrice via channels (not shown) positioned in first head 706 and second head 712. Handle 720 is designed in a substantially elongated prolate spheriodal shape so that the center portion is of sufficient mass and shape to allow a user proper grip and the end portions are of smaller dimensions to allow for the insertion into a user's oral cavity as well as the incorporation of a ball 722 and socket 724 joint. Specifically, at a first end of handle 720 and a second end of handle 720, a socket portion of the ball and socket joint is present. Similarly, a ball is formed at the non-bristle portion of first head 706 and a ball is formed at the non-bristle portion of second head 712 to allow for the stable insertion and snap of first head 706 and second head 712 into handle 710 in the direction depicted. Of course, removal of first head 706 and second head 712 is accomplished by applying force in the opposing direction and allows for ease of removal of the heads to allow for easy disposal and/or replacement with new heads exhibiting the same cleaning elements or different cleaning elements as desired by the user.

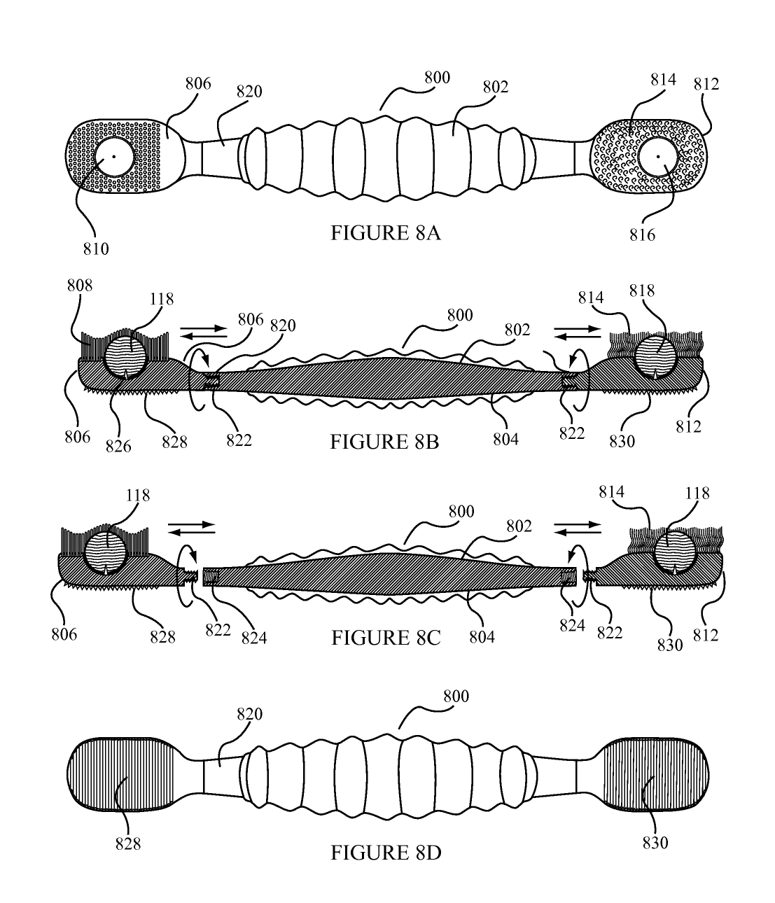

While a ball and socket joint is depicted in the alternate embodiment of FIG. 7A through FIG. 7D, one of ordinary skill in the art will readily recognize that various connection structures may be employed which ease in manufacture such as the screw connection employed in the further alternate embodiment of FIGS. 8A through FIG. 8D. FIG. 8A through FIG. 8D depict an alternate embodiment of the present invention wherein oral hygiene implement 800 includes a plurality of removable and replaceable heads to allow for the incorporation of a series of oral hygiene cleaning implements. Specifically, FIG. 8A depicts a top view of oral hygiene implement 800 in accordance with the alternate embodiment, FIG. 8B depicts a cross-sectional side view of oral hygiene implement 800 in accordance with the alternate embodiment with attached first head 806 and second head 812, FIG. 8C depicts a cross-sectional side view of oral hygiene implement 800 in accordance with the alternate embodiment with attached first head 806 and second head 812, and FIG. 8D depicts a bottom view of oral hygiene implement 800 in accordance with the alternate embodiment.

Oral hygiene implement 800 of FIG. 8A through FIG. 8D of the present invention incorporates handle 820 and upper ridge grip 802. Oral care implement 800 includes first head reservoir 810 for placement of dentifrice capsule 118 therein positioned on first head 806, second head reservoir 816 for placement of dentifrice capsule 118 therein positioned on second head 812, first head bristles 808, second head bristles 814, first head cleaning element 828 (shown as a tongue cleaning implement), and second head cleaning element 830. While the present embodiment of the invention depicting first head cleaning element 828 and second head cleaning element 830 do not illustrate a reservoir for dentifrice, it is contemplated by the present invention that the corresponding heads may be manufactured of sufficient size and head to allow these cleaning elements to incorporate a reservoir for the insertion of dentifrice therein. Thus, it is contemplated by the present invention that four reservoirs for the acceptance of dentifrice may be incorporated into a single implement depending on various cleaning elements utilized. First head bristles 808 and second head bristles 814 are positioned in a lateral arrangement allowing for the promulgation of dentifrice between such bristles and redistribution of the dentifrice via channels (not shown) positioned in first head 806 and second head 812. Handle 820 is designed in a substantially elongated prolate spheriodal shape so that the center portion is of sufficient mass and shape to allow a user proper grip and the end portions are of smaller dimensions to allow for the insertion into a user's oral cavity as well as the incorporation of screw joint. Specifically, at a first end of handle 820 and a second end of handle 820, a female end 824 of the screw joint is present. Similarly, a male end 822 of screw joint is formed at the non-bristle portion of first head 806 and a male end 822 of screw joint is formed at the non-bristle portion of second head 812 to allow for the stable insertion and screw (shown in the counter-clockwise direction) of first head 806 and second head 812 into handle 810 in the direction depicted. Of course, removal of first head 806 and second head 812 is accomplished by unscrewing in the opposing direction thereby allowing for ease of removal of the heads to allow for easy disposal and/or replacement with new heads exhibiting the same cleaning elements or different cleaning elements as desired by the user.

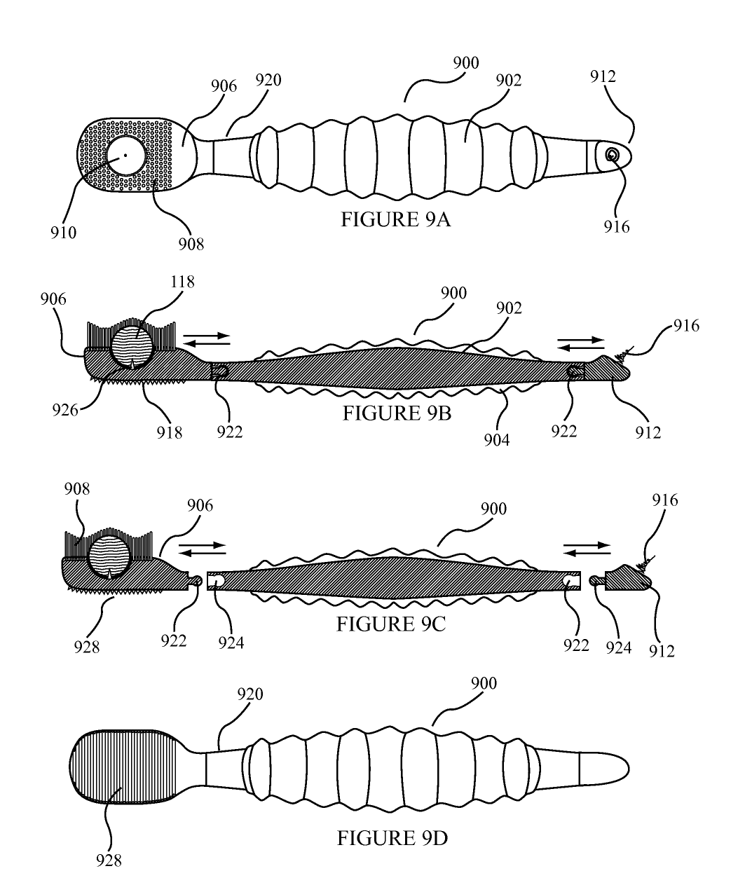

FIG. 9A through FIG. 9D depict an alternate embodiment of the present invention wherein oral hygiene implement 900 includes a plurality of removable and replaceable heads to allow for the incorporation of a series of oral hygiene cleaning implements. Specifically, FIG. 9A depicts a top view of oral hygiene implement 900 in accordance with the alternate embodiment, FIG. 9B depicts a cross-sectional side view of oral hygiene implement 900 in accordance with the alternate embodiment with attached first head 906 and second inclined interdental brush head 912, FIG. 9C depicts a cross-sectional side view of oral hygiene implement 900 in accordance with the alternate embodiment with attached first head 906 and second inclined interdental brush head 912, and FIG. 9D depicts a bottom view of oral hygiene implement 900 in accordance with the alternate embodiment.

Oral hygiene implement 900 of FIG. 9A through FIG. 9D of the present invention incorporates handle 920, upper ridge grip 902, and lower ridge grip 904. While upper ridge grip 902 and lower ridge grip 904 are depicted as two distinct portions, it is recognized that a single ridge grip may be utilized which travels entirely around Oral care implement 900 includes first head reservoir 910 for placement of dentifrice capsule 118 therein positioned on first head 906, second inclined interdental brush head 912, first head bristles 908, first head cleaning element 928 (shown as a tongue cleaning implement), and coiled bristles 916. Handle 720 is designed in a substantially elongated prolate spheriodal shape so that the center portion is of sufficient mass and shape to allow a user proper grip and the end portions are of smaller dimensions to allow for the insertion into a user's oral cavity as well as the incorporation of a ball 922 and socket 924 joint. Specifically, at a first end of handle 920 and a second end of handle 920, a socket portion of the ball and socket joint is present. Similarly, a ball is formed at the non-bristle portion of first head 906 and a ball is formed at the non-bristle portion of second inclined interdental brush head 912 to allow for the stable insertion and snap of first head 906 and second inclined interdental brush head 912 into handle 920 in the direction depicted. Of course, removal of first head 906 and second inclined interdental brush head 912 is accomplished by applying force in the opposing direction and allows for ease of removal of the heads to allow for easy disposal and/or replacement with new heads exhibiting the same cleaning elements or different cleaning elements as desired by the user.

FIG. 10 depicts an expanded cross-sectional side view of the ball and socket snap head in accordance with the alternate embodiment disclosed in FIG. 7A, FIG. 7B, FIG. 7C, and FIG. 7D of the present invention. The expanded view of first head 706 includes first head reservoir 710 for placement of dentifrice capsule 118 among first head bristles 708. In this image, first head bristles 708 are constructed of conical shape to allow for acute cleaning and flossing when utilized by the user. First head bristles 708 are positioned in a lateral arrangement allowing for the promulgation of dentifrice between such bristles and redistribution of the dentifrice via channels (not shown) positioned in first head 706 First head further includes first head cleaning element 728 (shown as a tongue cleaning implement) as well as dentifrice capsule puncture 1032 which allows for the puncture of dentifrice capsule 118 when pressure is applied by the user once positioned in the oral cavity. As previously discussed, dentifrice capsule 118 can be manufactured of suitably thin material so that use of dentifrice capsule puncture 1032 is optional. Ball 722, positioned at the non-bristle portion of first head 706 allows for the stable insertion and snap, as well as the removal of, first head 706.

FIG. 11 depicts a cross-sectional side view of the twist replaceable head system in accordance with the alternate embodiment disclosed in FIG. 8A, FIG. 8B, FIG. 8C, and FIG. 8D of the present invention. The expanded view of first head 806 includes first head reservoir 810 for placement of dentifrice capsule 118 among first head bristles 808. In this image, first head bristles 808 are constructed of substantially cylindrical shape to allow for uniform, general cleaning when utilized by the user. First head bristles 808 are positioned in a non-uniform lateral arrangement. First head further includes first head cleaning element 828 (shown as a tongue cleaning implement) as well dentifrice capsule puncture 1132 which allows for the puncture of dentifrice capsule 118 when pressure is applied by the user once positioned in the oral cavity. As previously discussed, dentifrice capsule 118 can be manufactured of suitably thin material so that use of dentifrice capsule puncture 1132 is optional. Male end 822 of screw joint, positioned at the non-bristle portion of first head 806 allows for the stable insertion and screw, as well as the removal of, first head 806.

FIG. 12 depicts an expanded cross-sectional side view of the ball and socket snap second inclined interdental brush head 912 in accordance with the alternate embodiment disclosed in FIG. 7A, FIG. 7B, FIG. 7C, and FIG. 7D of the present invention. Ball 922, positioned at the non-bristle portion of second inclined interdental brush head 912 allows for the stable insertion and snap, as well as the removal of, second inclined interdental brush head 912. The expanded view of second inclined interdental brush head 912 depicts coiled bristles 916. While coiled bristles 916 are depicted in the present invention, one of ordinary skill in the art will readily recognize that various bristle arrangements may be used as is common in the creation of interdental brushes such as narrow stem and radiating bristle rings of gradually increasing length project, rubberized conical shapes, etc. Further, it is contemplated that second inclined interdental brush head 912 may be mounted in socket of handle in either an up position or down position based on user preference and that a shield may be provided to protect the user and the brush during non-use.

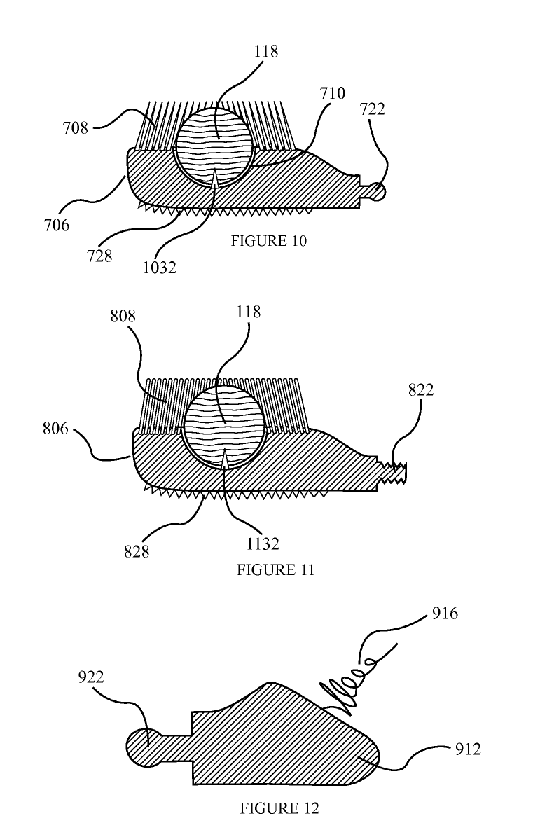

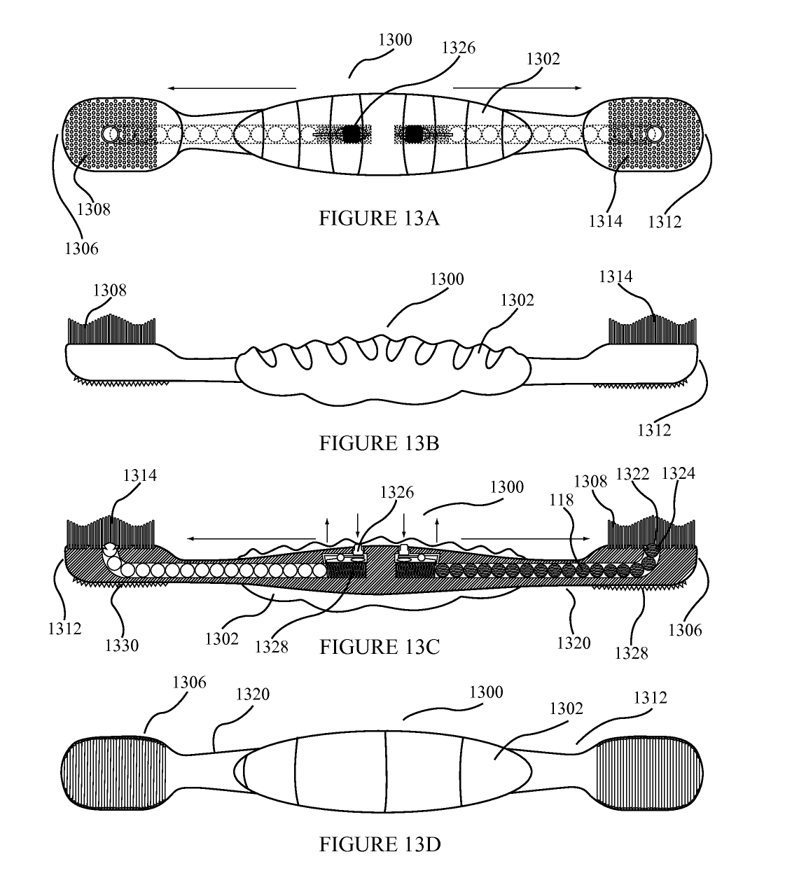

FIG. 13A through FIG. 13D depict a further alternate embodiment of the present invention wherein oral hygiene implement 1300 includes a spring loaded dentifrice release mechanism. Specifically, FIG. 13A depicts a top view of oral hygiene implement 1300 in accordance with the alternate embodiment, FIG. 13B depicts a cross-sectional side view of oral hygiene implement 1300 in accordance with the alternate embodiment, FIG. 13C depicts a cross-sectional side view of oral hygiene implement 1300 in accordance with the alternate embodiment, and FIG. 13D depicts a bottom view of oral hygiene implement 1300 in accordance with the alternate embodiment.

Oral hygiene implement 1300 of FIG. 13A through FIG. 13D of the present invention incorporates handle 1320 and full grip 1302. Oral care implement 1300 includes first head 1306, second head 1312, first head bristles 1308, second head bristles 1314, first head cleaning element 1328 (shown as a tongue cleaning implement), and second head cleaning element 1330. Handle 1320 is designed to include a channel for the storage and distribution of a plurality of dentifrice capsule 118 via release mechanism employing a spring release button 1326 for releasing a spring 1328. In this example, oral care implement 1300 is provided in “loaded” state with dentifrice capsules 118 disposed therein and it is further contemplated by the present invention that release mechanism of oral care implement 1300 may be recharged with dentifrice capsules 118. Alternatively, oral care implement 1300 may be designed to be discarded once the dentifrice capsules 118 therein are discharged. As shown, dentifrice capsules 118 on one side of oral care implement 1300 are different than dentifrice capsules 118 on the opposing side of oral care implement 1300 (e.g., one side contains gel-based toothpaste and the opposing side contains mouthwash capsules).

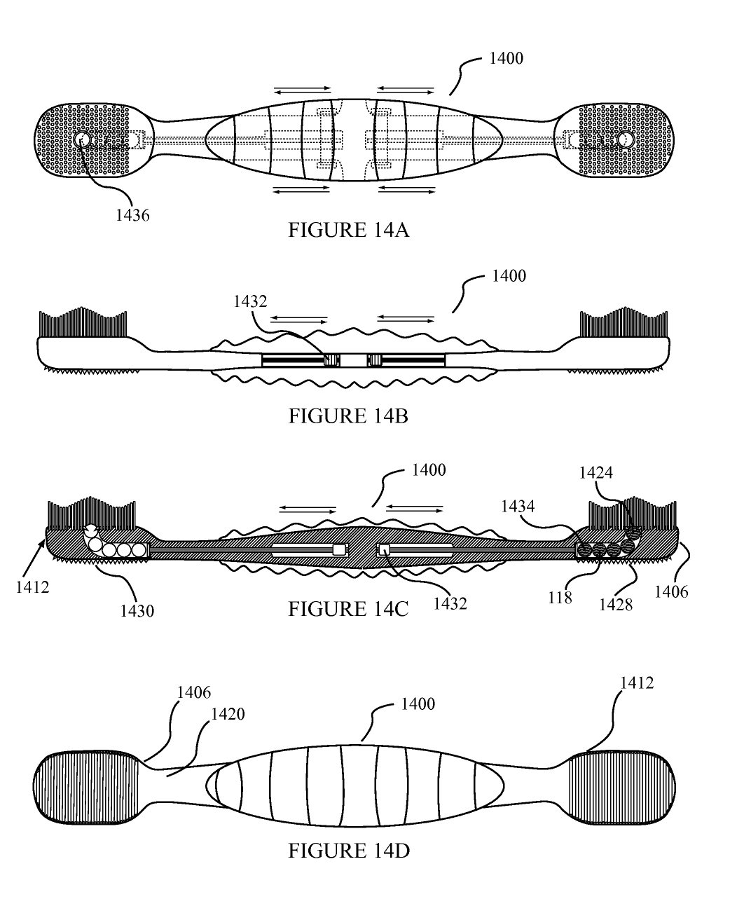

FIG. 14A through FIG. 14D depict a further alternate embodiment of the present invention wherein oral hygiene implement 1400 includes a piston loaded dentifrice release mechanism. Specifically, FIG. 14A depicts a top view of oral hygiene implement 1400 in accordance with the alternate embodiment, FIG. 14B depicts a cross-sectional side view of oral hygiene implement 1400 in accordance with the alternate embodiment, FIG. 14C depicts a cross-sectional side view of oral hygiene implement 1400 in accordance with the alternate embodiment, and FIG. 14D depicts a bottom view of oral hygiene implement 1400 in accordance with the alternate embodiment.

Oral hygiene implement 1400 of FIG. 14A through FIG. 14D of the present invention incorporates handle 1420 and full grip 1402. Oral care implement 1400 includes first head 1406, second head 1412, first head bristles 1408, second head bristles 1414, first head cleaning element 1428 (shown as a tongue cleaning implement), and second head cleaning element 1430. Handle 1420 is designed to include a channel for the storage and distribution of a plurality of dentifrice capsules 118 via release mechanism employing a push button 1426 for applying pressure via a slide piston 1428 for pushing dentifrice capsules 118. In this example, oral care implement 1400 is provided in “loaded” state with dentifrice capsules 118 disposed therein and it is further contemplated by the present invention that release mechanism of oral care implement 1400 may be recharged with encapsulated dentifrice capsules 118. Alternatively, oral care implement 1400 may be designed to be discarded once the dentifrice capsules 118 therein are discharged. As shown, dentifrice capsules 118 on one side of oral care implement 1400 are different than dentifrice capsules 118 on the opposing side of oral care implement 1400 (e.g., one side contains gel-based toothpaste and the opposing side contains mouthwash capsules).

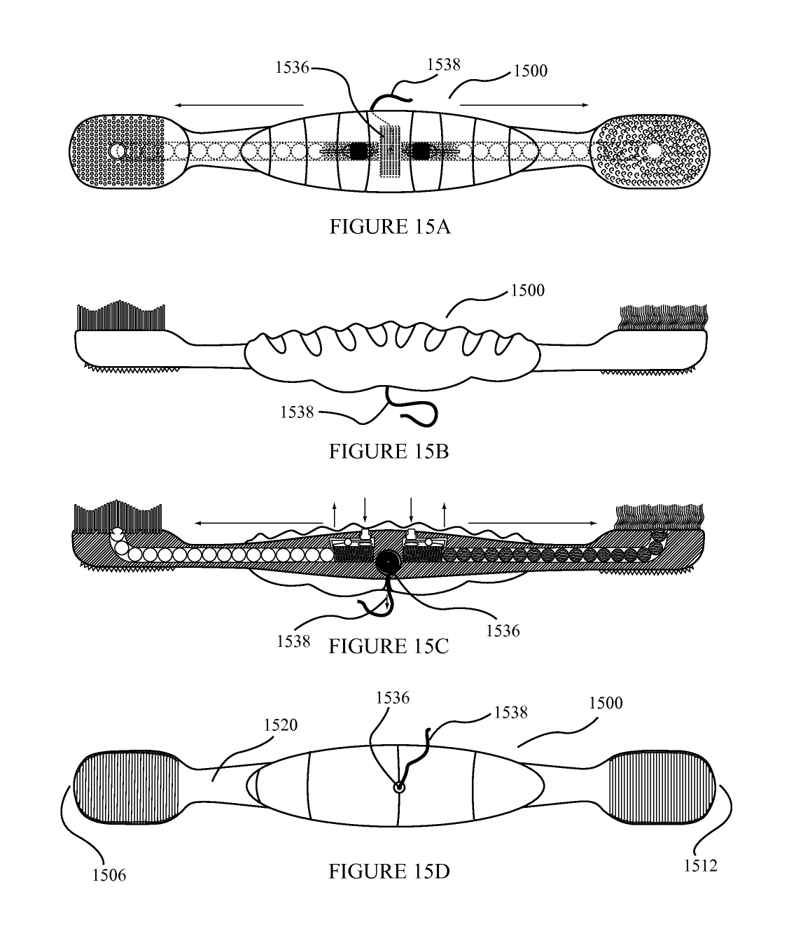

Turning to the next set of figures, FIG. 15A through FIG. 15D depict a further alternate embodiment of the present invention wherein oral hygiene implement 1500 includes a spring loaded dentifrice release mechanism and a dental floss storage and release cavity. Specifically, FIG. 15A depicts a top view of oral hygiene implement 1500 in accordance with the alternate embodiment, FIG. 15B depicts a cross-sectional side view of oral hygiene implement 1500 in accordance with the alternate embodiment, FIG. 15C depicts a cross-sectional side view of oral hygiene implement 1500 in accordance with the alternate embodiment, and FIG. 15D depicts a bottom view of oral hygiene implement 1500 in accordance with the alternate embodiment.

Oral hygiene implement 1500 of FIG. 15A through FIG. 15D of the present invention incorporates handle 1520 and full grip 1502. Oral care implement 1500 includes first head 1506, second head 1512, first head bristles 1508, second head bristles 1514 employing a waved bristle structure, first head cleaning element 1528 (shown as a tongue cleaning implement), and second head cleaning element 1530. Handle 1520 includes dental floss storage and release cavity 1536 designed to house and dispense dental floss 1538. Dental floss storage and release cavity 1536 can further employ a cutter to cut dental floss 1538 at a desired length and can also include a retraction mechanism with pull lock to dispense a desired length of dental floss 1538 and retract to a locking point. Handle 1520 is designed to include a channel for the storage and distribution of a plurality of dentifrice capsule 118 via release mechanism employing a spring release button 1526 for releasing a spring 1528. In this example, oral care implement 1500 is provided in “loaded” state with dentifrice capsules 118 disposed therein and it is further contemplated by the present invention that release mechanism of oral care implement 1500 may be recharged with dentifrice capsules 118. Alternatively, oral care implement 1500 may be designed to be discarded once the dentifrice capsules 118 therein are discharged. As shown, dentifrice capsules 118 on one side of oral care implement 1500 are different than dentifrice capsules 118 on the opposing side of oral care implement 1300 (e.g., one side contains paste-based toothpaste and the opposing side contains water soluble powder capsules).

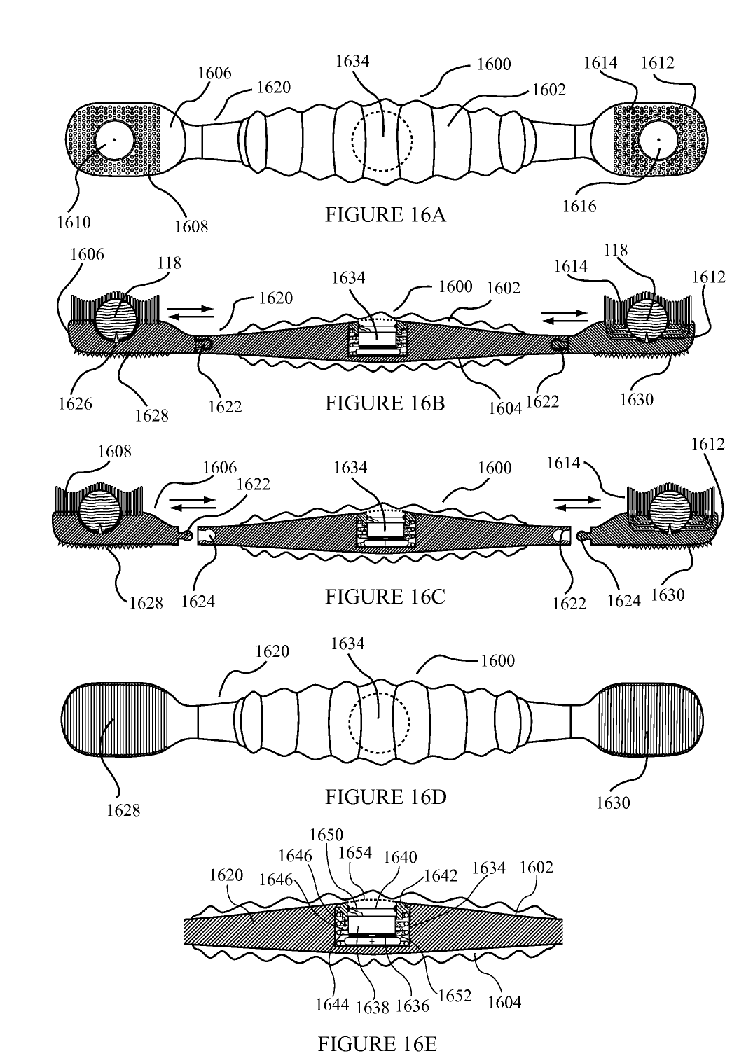

FIG. 16A through FIG. 16E depict an alternate embodiment of oral hygiene implement 1600 including musical device 1634 positioned in handle 1620. Oral hygiene implement 1600 is composed of upper grip 1602, lower grip 1604 removable and replaceable snap first head 1606, removable and replaceable snap second head 1612, first head bristles 1608, second head bristles 1614, first head reservoir 1610, second head reservoir 1616, first cleaning element 1628, and second cleaning element 1630. Dentifrice 118 is positioned in first head reservoir 1610 and second head reservoir in proximity to dentifrice capsule puncture 1626. Dentifrice 118 is promulgated via between bristles via channels 1632 in first head 1606 and second head 712. Removable and replaceable snap first head 1606 and removable and replaceable snap second head 1612 are shown in an inserted state (see FIG. 16B) and an un-inserted state (see FIG. 16C). At a first end of handle 1620 and a second end of handle 1620, a socket portion of a ball and socket joint is present. A ball is formed at the non-bristle portion of first head 1606 and a ball is formed at the non-bristle portion of second head 1612 to allow for the insertion and snap of first head 1606 and second head 1612 into handle 1620 in the direction depicted. Similarly, removal of first head 1606 and second head 1612 is accomplished by applying force in the opposing direction.

FIG. 16E depicts an exploded view cross-sectional side view of the center portion of oral hygiene implement 1600 depicted in FIG. 16B in accordance with an alternate embodiment of the present invention. In the exploded view, intricacies of musical device 1634 positioned in handle 1620 are further apparent. Specifically, musical device 1634 is comprised of at least battery 1636, storage unit 1638, speaker 1640, switch 1642 comprised of a retractable spring-loaded button, contact 1644 for electronic and sound storage 1644, connection 1646 between electronic and sound storage, battery connection 1648 between battery, electronic, and sound storage, protector 1650 composed of perforations or similar thin substrate designed to allow for the sound to emit at an appropriate audible level.

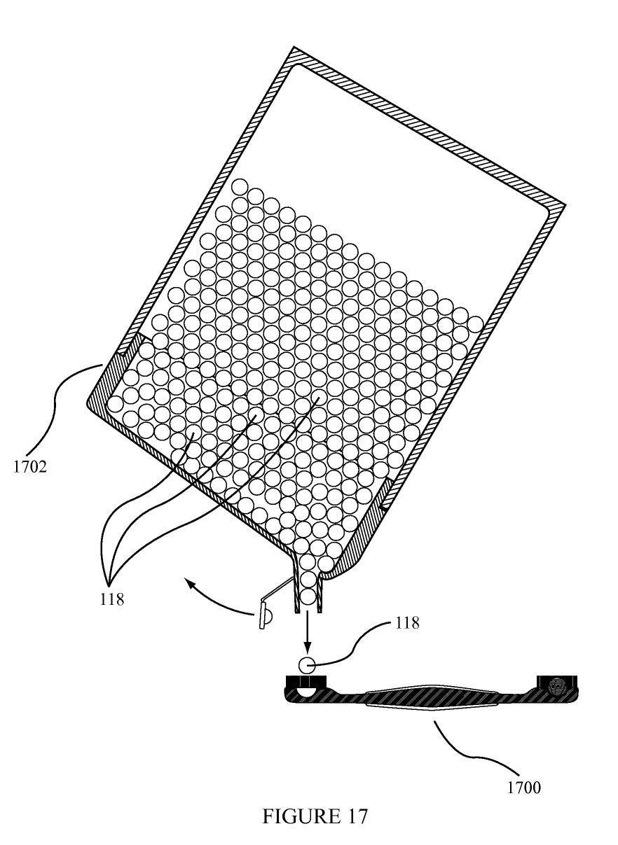

FIG. 17 depicts a perspective of dispenser 1702 for storing, dispensing, and refilling dentifrice capsules for use with the various embodiments of the present invention. Dispenser includes a storage vial 1704 and a release portion 1706. Dispenser is manufactured of any suitable plastic or like material which allows for the safe and hygienic storage and distribution of the dentifrice capsules 118 for use in refilling the various oral care implements disclosed herein. While a vial is shown, it is also contemplated by the present invention that various additional dispensers may be employed, such as blister pack units.

The foregoing description of the embodiments have been set forth in considerable detail for the purpose of making a complete disclosure of the present invention. It will be appreciated by those skilled in the art that changes could be made to the embodiments described above without departing from the broad inventive concept thereof. It is understood, therefore, that this invention is not limited to the particular embodiments disclosed, but it is intended to cover all modifications that are within the scope and spirit of the invention as defined by the appended claims.

What is claimed is:

1. An oral hygiene implement for improved oral hygiene, said toothbrush comprising:
an elongated handle containing dental floss storage and distribution system;
a first interchangeable head removably connected to said elongated handle having a first reservoir;
a first dentifrice capsule positioned within said first reservoir;
a second interchangeable head removably connected to said elongated handle having a second reservoir; and
a second dentifrice capsule positioned within said second reservoir.

2. The oral hygiene implement according to claim 1 wherein said cleaning elements are selected from a group consisting of bristles, interdental brushes, and scrapers.

3. The oral hygiene implement according to claim 1 wherein said dentifrice is selected from a group consisting of pastes, gels, liquids, films, and powders.

4. The oral hygiene implement according to claim 1 wherein said dentifrice is encapsulated in a non-toxic and biocompatible thin coating and designed to be ruptured.

5. The oral hygiene implement according to claim 1 wherein said elongated handle, first interchangeable head, and second interchangeable head are manufactured from a thermoplastic and designed to be used and discarded.

6. The oral hygiene implement according claim 1 wherein said first reservoir and second reservoir employ prongs to hold and position said dentifrice and assist in rupturing said dentifrice.

7. An oral hygiene implement for improved oral hygiene, said toothbrush comprising:
an elongated handle containing dental floss storage and distribution system;
a first interchangeable head removably connected to said elongated handle having a first reservoir and at least two cleaning elements;
a first dentifrice capsule positioned within said first reservoir;
a second interchangeable head removably connected to said elongated handle having a second reservoir and at least two cleaning elements; and
a second dentifrice capsule positioned within said second reservoir.

8. The oral hygiene implement according to claim 7 wherein said cleaning elements are selected from a group consisting of bristles, interdental brushes, and scrapers.

9. The oral hygiene implement according to claim 7 wherein said dentifrice is selected from a group constiting of pastes, gels, liquids, films, and powders.

10. The oral hygiene implement according to claim 7 wherein said dentifrice is encapsulated in a non-toxic and biocompatible thin coating and designed to be ruptured.

11. The oral hygiene implement according to claim 7 wherein said elongated handle, first interchangeable head, and second interchangeable head are manufactured from a thermoplastic and designed to be used and discarded.

12. The oral hygiene implement according claim 7 wherein said first reservoir and second reservoir employ prongs to hold and position said dentifrice and assist in rupturing said dentifrice.

13. A method for practicing improved oral hygiene, said method comprising:
removing floss from an elongated handle of a an oral hygiene implement containing a dental floss storage and distribution system for flossing teeth with said floss;
attaching a first interchangeable head having a first reservoir to said elongated handle;
attaching a second interchangeable head having a second reservoir to said elongated handle;
brushing teeth by creating friction between said first interchangeable head and teeth;
freshening breath by creating friction between said second interchangeable head and teeth; and
discarding said floss and said first and second interchangeable heads.

14. The method according to claim 13 further comprising the step of cleaning said teeth using a cleaning element selected from a list of bristles, interdental brushes, and scrapers.

15. The method according to claim 13 wherein said first reservoir is filled with a dentifrice selected from a group consisting of pastes, gels, liquids, films, and powders.

16. The method according to claim 13 wherein said second reservoir is filled with a dentifrice selected from a group consisting of pastes, gels, liquids, films, and powders.
